(19) United States
(12) Patent Application Publication
(10) Pub. No.: US 2014/0114717 A1
(43) Pub. Date: Apr. 24, 2014

(54) Task Schedule Modification

(71) Applicant: Moose Loop Holdings, LLC, Salt Lake City, UT (US)

(72) Inventors: Ken R. Davis, Salt Lake City, UT (US); Fraser M. Smith, Salt Lake City, UT (US)

(73) Assignee: Moose Loop Holdings, LLC, Salt Lake City, UT (US)

(21) Appl. No.: 13/838,619

(22) Filed: Mar. 15, 2013

Related U.S. Application Data
(60) Provisional application No. 61/697,188, filed on Sep. 5, 2012.

(51) Int. Cl. G06Q 10/10; G06Q 30/06

(52) U.S. Cl. CPC G06Q 10/1097; G06Q 30/0621
USPC 705/7.21; 705/26.5

(57) ABSTRACT

Technology is described for modifying a task frequency. The method may include setting a task price for a task based on task details and statistical price data. The task frequency of the task can be modified. Another operation can be computing a pro-rata value created due to modifying the task frequency. The pro-rata value can be divided between a service provider and a customer to provide a monetary benefit to either the service provider or to the customer using the processor.

### PRIORITY CLAIM

Priority is claimed to U.S. Provisional Patent Application Ser. No. 61/697,188, filed Sep. 5, 2012, which is hereby incorporated herein by reference in its entirety.

### BACKGROUND

Many goods can be purchased in a commoditized way. A consumer can have certain criteria when deciding to purchase goods, and if the goods meet the desired criteria, then the consumer generally does not care who provides the goods.

Services have traditionally been less commoditized. Rather, services are typically purchased after comparing service providers to one another. For example, service providers or service providers can be compared through a bidding process, interviews, and/or online user feedback ratings. Even such service provider comparisons can be challenging for a consumer to interpret due the non-uniformity in services supplied by various service providers. This has resulted in uncertainty to the consumer as to the comparative cost of services, reliability of services, and the quality of services provided by service providers.

### BRIEF DESCRIPTION OF THE DRAWINGS

FIG. 1 is a block diagram illustrating an example of a system for providing services, customer and task management, and scheduling capability.

FIG. 2 illustrates an example service provider scheduling tool.

FIG. 3 illustrates an example scheduling screen.

FIG. 4 illustrates an example task management screen with details about a task.

FIG. 5 illustrates an example of a weekly calendar showing tasks to be performed by a service provider during a time period.

FIG. 6 illustrates an example of a calendar with weightings associated with each possible day for re-scheduling.

FIG. 7 is a flowchart illustrating of an example method for modifying a task frequency.

FIG. 8 is a flowchart illustrating of an example method for scheduling tasks in response to blackout periods.

FIG. 9 is block diagram illustrating an example of a computing device that may be used in scheduling.

### DETAILED DESCRIPTION

Reference will now be made to the examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure are to be considered within the scope of the description.

A technology is described for efficiently providing access to services via a networked computer system. More accurate and efficient access to services may commoditize services not traditionally commoditized in the past by allowing the services to be priced and delivered in a more uniform fashion. While access may be provided for any of a nearly limitless number of services provided by service providers, examples of commoditization of services may be applied to many areas including various yard and home services, such as: lawn mowing, lawn fertilizing, basic home repairs, painting, cleaning, gardening, small appliance repair, etc. A service provider can be any service provider, contractor, service contractor, service group, or service supply entity that provides a service to a customer.

This technology may allow a user to select a service or task (e.g., lawn mowing) to be purchased electronically, and a user interface on a client device can present choices to the customer that include task parameters and other details about the service. These service parameters can be used provide efficient commodity-like pricing. The service parameters may include task details or variables that affect pricing and other factors for the task. In a lawn mowing example, parameters may be collected from a customer that include: lawn shape and size, length of grass, type of grass, physical location, quality of service provider desired, need for repeat service, etc. The pricing of the service or task may be a fixed price that is calculated using existing facts about the service and statistical data known about task prices in a geographical area, etc. With iterated services and sufficient service provider and customer feedback, the pricing can become more accurate over time such that each task may become more like a standard unit of work that is priced with increasing accuracy. The terms service and task may be used interchangeably in this description.

Commoditized tasks purchased by a customer through this technology may be matched with one of a plurality of service providers who have schedule availability to perform the task. Customers may have the opportunity to select preferred service providers from a list of available service providers, but the selection of a service provider is optional. A customer may be encouraged to allow the service provider to be assigned automatically using a computing device, and the customer may be encouraged not to select a service provider through various pricing and other inducements. As the services become more commoditized, then the service providers become more easily interchangeable. This may provide an experience similar to a customer's experience in a retail setting where the customer is more interested in the convenience of acquiring goods at a known quality, quantity and/or price, rather than which individual made the goods being purchased.

Service providers can be matched to customers on the basis of a number of additional parameters identified by the service providers and these parameters may include: shortest distance to customer, higher schedule availability, matching skill level, quality level desired, availability of required tools to perform the task, and other parameters. The value provided to service providers may be increased by providing more customers, assigning customers situated closer together, automated pricing, back office accounting and management functions, and other ways that improve service provider efficiency and/or boost service provider revenues.

Using a commodity approach can simplify the service purchase process and can make buying services more analogous to buying tangible goods through a retail store. Detailed methods may be used to compute a fair market pricing for the service based on customer provided specifications about the service to be performed. The fair market pricing can allow a fixed price to be presented to the customer, at the point of sale, and allow the customer to complete a transaction immediately.

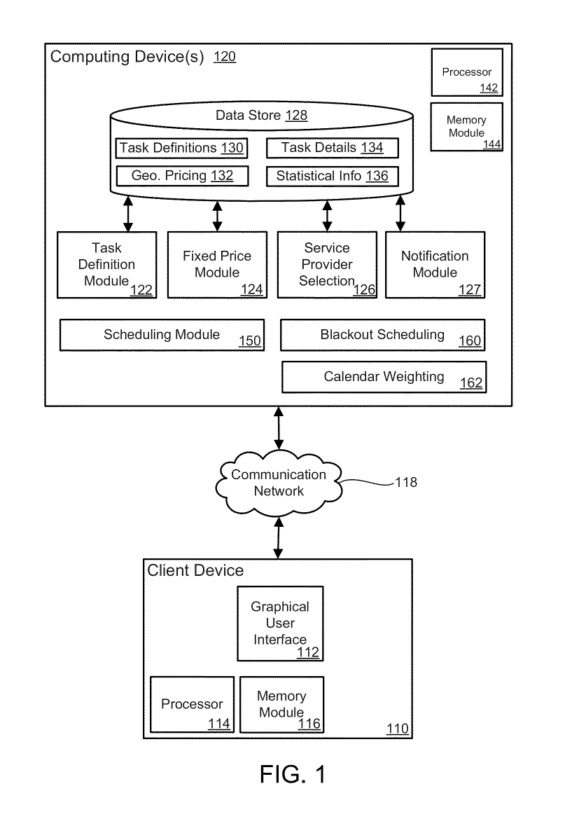

As illustrated in FIG. 1, a system can be used for delivering, pricing, assigning, managing and exchanging tasks. The system may include a client device 110 through which a user can access information related to tasks and customers over a communications network 118. The communications network can be a local area network (LAN), wide area network (WAN), or the internet. A graphical user interface 112 can be provided to the user using the client device 110 to access the task, customer, and related information located on a separate computing device 120. A client device 110 with a graphical user interface 112 may be used by either a service provider or a customer.

Parameters for a task that the customer desires to be performed can be received by the graphical user interface 112 of the client device 110. For example, the customer may type, speak, write, or select task parameters that the client device 110 can capture. Payment for the task selected by the customer may also be supplied via the graphical user interface. In one example, payment via a credit card or debit transaction is collected before the task is assigned to a service provider for performance. The client device may include a processor 114 and a memory module 116. A client device 110 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display that may present the graphical user interface 112.

The parameters for a task collected by the client device 110 can be sent to a computing device 120. The computing device 120 may be provided with modules for providing and managing tasks and customers. Additional related functions for communication, fixed pricing, service provider selection, task exchange, and task valuation can also be provided, as will be described later. The computing device 120 may be a single server, a distributed server environment, a server farm, or any computing device or group of computing devices that may service requests from other computing devices or programs. In addition, the computing device may include one or more processors 142 and memory modules 144.

The parameters that are requested from the customer can be collected and used by a task definition module 122. The task definition module 122 can also obtain a task definition for a task which describes task details to be performed for a customer. In addition, the task definition module 122 can access the task definitions 130 located in the data store 128, and the task definitions may include specific definitions of what procedures are going to be undertaken for a task. For example, the task definition can define a mowing task as: 1) cutting grass and 2) blowing loose grass off sidewalks. The task definition may also include a question template to send to customers to obtain the factual task parameter information that is desired to be captured from the customer about a task type. The customer's replies and specific factual data collected in response to the questions about tasks can be stored in the task details 134 data store. The data store 128 may refer to any device or combination of devices capable of storing, accessing, organizing, and/or retrieving data, which may include any combination and number of data servers, relational databases, object oriented databases, simple web storage systems, distributed storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media.

A fixed price for a task may be determined based on the parameters collected about the task. Statistical price data for tasks may also be used in calculating the fixed price for a task. As mentioned earlier, the fixed price is the fee under which a service provider is expected to perform the task for the customer after the service provider has received the task assignment. In one example, the service provider may simply work on tasks automatically assigned to the service provider's schedule, or in another example, the service provider may choose to approve work assignments in advance of scheduling. A significant portion of the retail fixed price charged to the customer can be paid to the service provider and a smaller portion of the fixed price may be retained by the entity operating the technology described in this description. For example, the fixed price can be calculated using a fixed price module 124 to set a task price for the task based on the task details and statistical price data identified in the statistical information 136 data store. The fixed price can be calculated, in part, using the task details 134 provided by the customer, as stored in the data store 128. These task details may include one or more of the following details: time since last service performed, square dimensions of project, current state or quality of project, desired state or quality of project, number of hours service may be performed, distance to be traveled, number of units to be transported, average amount of time similar tasks have historically consumed, average cost of parts similar tasks have historically consumed, number of levels or stories of a structure, number of rooms in a structure, square dimensions of a structure, the presence of exterior improvements such as a swimming pool, hot tub or basketball court, the desired start date, the desired completion date, whether a specific time or an approximate time is desired for performance of the service, the number of legal steps required by law, the grade or style of materials used, the frequency of recurrence, the depth or quantity of material to be moved or removed, the linear dimensions of project, etc.

Additional input parameters may also be obtained automatically from third parties. For example, a house lot size, square footage of the house, number of bedrooms and bathrooms, and related real property information can be obtained for a real estate information service provider. Similarly, mapping data and address correction data can be obtained from a mapping information service provider. Weather data can be obtained (e.g., for snow clearing predictions) including snow accumulation hourly actual measurements along with future predictions, temperature and humidity for estimating snow ablation from a weather information source.

Service provider feedback about customers and tasks can help refine task pricing. In some cases, there may be unexpected aspects of the tasks that occur with certain customers or certain types of tasks. For example, edging a customer's lawn may be more difficult the first time where the customer has a very overgrown lawn. Customer feedback about service providers (quality, timeliness, speed, etc.) may also be used to refine the method of matching service providers with tasks. In addition, customer feedback can also be used in refining the task pricing.

As discussed, a service provider may be selected from among the plurality of service providers to perform the task. The service provider selection can take place using the service provider selection module 126. Criteria for selecting a service provider may include using at least one of the following: a distance between the service provider and customer, time slots made available by the service provider, a skill level of service requested, previous performance feedback of the service provider from prior customers, quality tier of a service provider, etc. Other criteria or metrics about service providers may also be used in selecting a service provider, as desired.

The customer and the service provider can be notified of the service provider selection using the notification module 127. In one example, the notification module may prepare a web page or a web application page to be sent to the customer. Alternatively, a notification can be sent through the graphical user interface 112 on the client device 110 using an application on the client device 110. Other types of notifications may include: emails, instant messages, text messaging, or any other message type that can be received by the customer. Once the service provider has been selected, then the service provider can be scheduled to perform the task. More specifically, the task can be added to an available time slot on the service provider's calendar, and the customer can be notified of the scheduled task time. The notification module can also prepare other network pages, web pages, or web application pages to communicate other information to the client device 110.

In one configuration, the technology may allow just a limited number of service providers per market. A market may be a geographical market or a specific task type in a geographical area. Each service provider may be notified that as long as the service provider is willing to perform the work received by the service provider from the system, the service provider can continue to participate. This may encourage service providers to quickly sign up for markets the service provider services, so the service provider does not lose out on the possibility of new customers received through the technology. Additional service provider slots in a given market might be made available as customer demand for services in a given market begins to exceed service provider supply.

The system illustrated by FIG. 1 can also provide tools to a service provider for: managing the service provider's customers, managing the service provider's team members, monitoring tasks and schedules, managing finances, finding new customers and other service provider related functions.

Some existing services for referring a service provider to a customer take input from customers and pass the customer information along to the service provider in the form of a lead. The service providers can then bid on the task and the customer is able to select from multiple bids. Such approaches have the customer return to the website and make an additional decision as to which of the many service providers who have bid the customer would like to use. While a bidding system is useful for connecting a service provider to a customer, the overall bidding process is slow and cumbersome. Furthermore, existing services typically do not act as a payment broker to give the customer control over payment to the services provider based on quality of work performed.

### Scheduling

The scheduling of the tasks and customer visits can be performed electronically, as described earlier. The computing device 120 of FIG. 1 may include a scheduling module 150 to schedule tasks purchased by a customer on a service provider's calendar once the service provider has accepted the task. In a simple example, a scheduled time can be selected that is a first available time slot for the service provider to perform the task.

A task can also be scheduled using a method to optimize a service provider's schedule while complying with a variety of constraints. For a service provider, one constraint may be which service schedule provides the most profit. However, a customer's constraint may be having the requested service(s) done as conveniently as possible, as quickly as possible, or at regular time interval that matches when the work needs to be done (e.g., when the lawn needs to be mowed or when the pool is expected to be dirty).

Finding a workable schedule that complies with both customer and service provider constraints can use the computing resources of the scheduling module 150. Consider a simple case where 40 tasks need to be scheduled for a service provider in a week. This might be an example schedule, as each task may take an hour on average and many service providers work 40 hours in a given week. Even with just 40 tasks, the possible number of schedules is 40 factorial or more than 8.159*10⁴⁷ possible schedules. If the average task length shrinks to 30 minutes on average giving a total of 80 tasks for a week, the number of possible schedules climbs to a staggering 7.157*10¹¹⁸ possible schedules. Computing an optimized schedule by testing every possible schedule combination to find a best schedule is likely to take significantly more computation cost than any optimal benefit provided to a service provider.

One less resource intensive example scheduling method may include starting with those scheduled tasks that are fixed on the schedule and then finding the next closest task slot that is available with respect to the fixed task. Then an additional task can be scheduling in the available task slot closest to the fixed task. A fixed task can be defined as a task that the customer specifies is to be done at a specific time. In other words, the schedule can then be filled in by finding the next closest schedule slots to the fixed items, and then the closest task slots to the tasks just scheduled, and so on until the schedule is filled.

Another possible scheduling method may be to implement a genetic (a.k.a., evolutionary) method. The genetic representation can be a task schedule, and the fitness function can be the profit of the service provider for completing the tasks. This method may differ from other methods that typically use either bit strings (as is typical) or using binary trees (also a common scenario), because this solution can use the schedule as the ‘chromosome’ for the method. At the method's core, the fitness function (the way to determine how good a schedule is) is just the total revenue provided minus the cost of completing the schedule. The revenue is just a simple calculation summing the revenue from each of the individual tasks to be completed. Some tasks may not be placed on a given schedule because the cost for completing the task might exceed the revenue cost of doing the task. For example, driving 1,000 miles to complete a $5 task may not be worthwhile.

The cost for completing a task may involve many variables, including:
1. Time to drive to and from a task.
2. Time to complete a task.
3. Material costs (gas, fertilizer, etc.)
4. Task risk factor (ex: how likely is the task to be as described, or will there be external factors in completing the task such as weather delays).

Customers may have a variety of scheduling options including: (a) allowing the customer to pick a service provider and schedule that is optimal, (b) requesting that the task be performed on a particular day of the week, (c) requesting that the task be performed during a particular block of time (e.g. the 3 hour block of time in the morning from 8 am to 11 am), (d) requesting a very specific time (e.g. task must be performed at 11:15 am), (e) or requesting some combination of any of the above. The execution of the “genetic” optimization can allow tasks to move around within the “anchored” constraints requested by the customer. Furthermore, the service providers can experiment with applying additional custom constraints or rules to tasks while the service providers are attempting to perform further optimizations or when the contractor needs to reschedule a task for reasons other than optimization. For example, if a service provider knows that the service provider needs to perform a task outside of the optimal scheduling location of the task (e.g. the service provider will be going on vacation on the normally scheduled time for the task), he can pose questions to the system like: (a) what is the next best time not on that day; (b) what is the next best time on Mondays; (c) what is the next best time between 8 am and 11 am on Mondays; etc.

While many methods for scheduling using a computing environment may be used, the methods described above differ from existing scheduling methods in that the present method applies scheduling methods to the service schedule optimization space. Additionally, the described scheduling methods can look for optimizations across service providers or teams within a single service provider. Finally, this method also finds a good-fit for both flexible and rigid requested schedules.

In one scheduling example, customers can specify a preferred time for scheduling a service to be performed within a time range with a given precision while still optimizing service provider scheduling. The method may include the operation of receiving user input from a customer to select a range of time (e.g., time of day). The range of time may be based on a plurality of available time slot ranges of a plurality of service providers for a service to be performed.

A range of amount of time in which the service can be performed based on the statistical variances of completion times of similar work (larger variance equals a larger range) can be computed. For example, a 5,000 square foot lawn may be expected to be mowed in 45 minutes and then 15 minutes can be allocated for travel and management tasks. The estimate of an amount of time to typically perform the service can also take into account statistical averages of previously computed work and the estimate can be used to fill that amount of time as a new task on a service provider's schedule.

Purchased tasks can be inserted adjacent to or near other tasks on the service provider's schedule, either before or after the new task, provided that insertion does not result in the estimated start time of that task or previously scheduled tasks falling outside of the range specified by the customer.

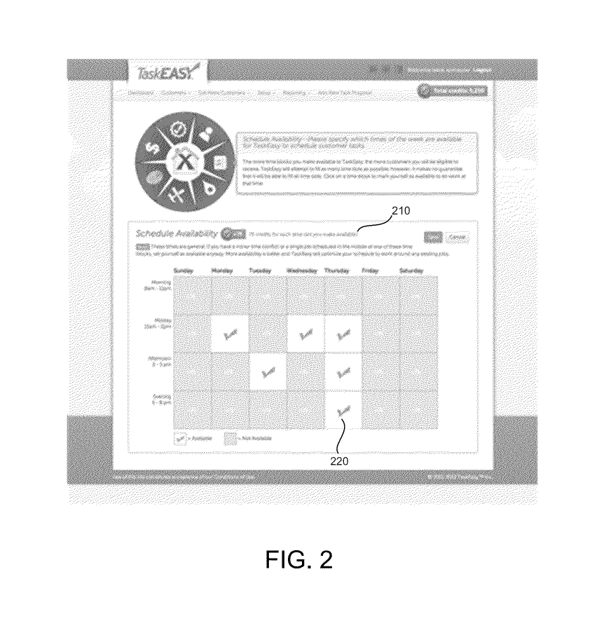

FIG. 2 illustrates a service provider scheduling tool where a service provider selects blocks of time 220 when the service provider can be available to work on tasks for customers. As a service provider makes blocks of time available for tasks, the service provider can receive credits 210 for making that time available and then receive tasks during the available time blocks.

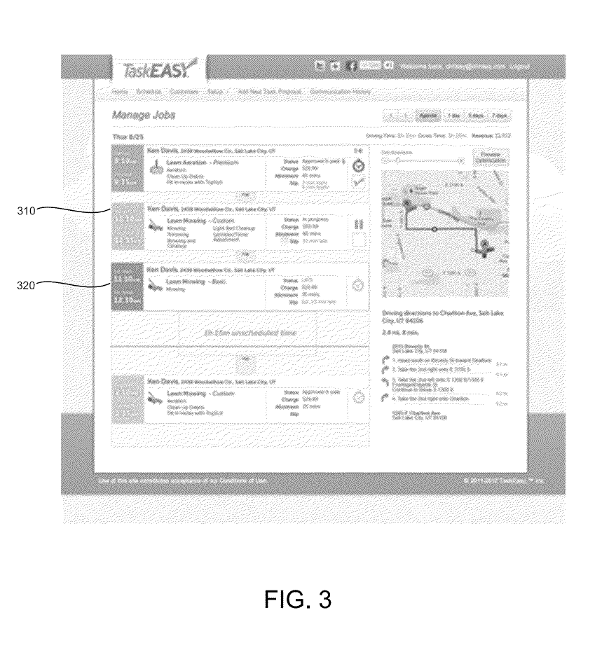

FIG. 3 illustrates an example scheduling screen that may be displayed on a client device or a mobile device. A service provider can access and view the service provider's schedule 310 of tasks purchased by customers and information related to those tasks. Scheduling and related information such as a task details, charges, start times, stop times, previous tasks, following tasks, and driving directions can be displayed. Using this dynamically changing schedule, the service provider can identify whether the service provider is meeting expected time targets on a current task. For example, the task may have an allotted time for completion and the service provider can view whether the scheduled time target was met or exceeded. The upcoming tasks can also be seen in the scheduling list 320.

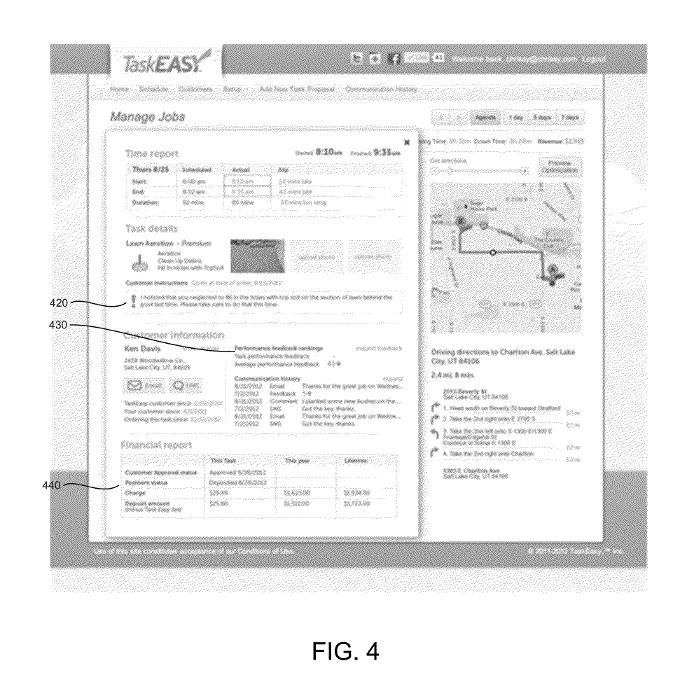

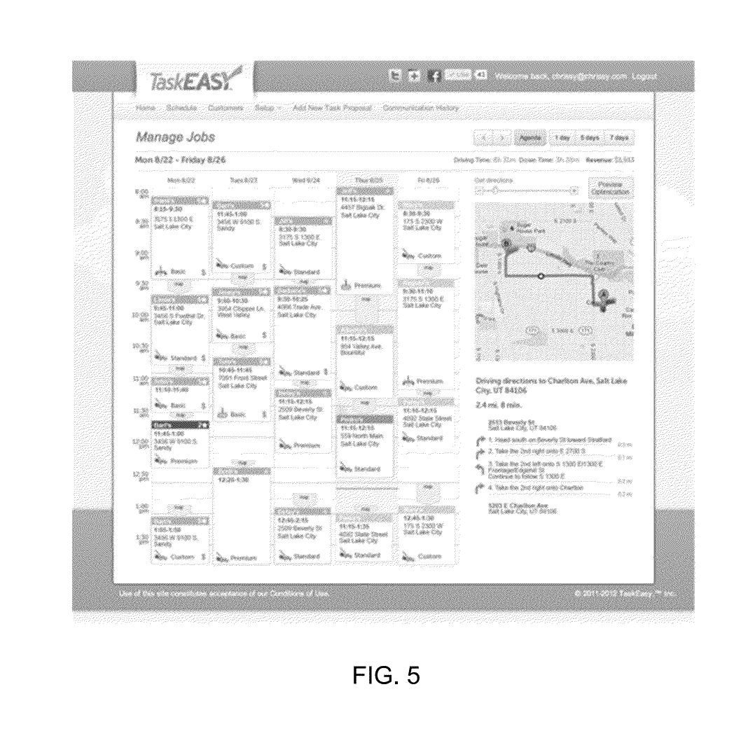

FIG. 4 illustrates an example task management interface screen with details about a task. This task management screen can include feedback from the customer 420 or similar types of comments. A rating 430 on the quality of the completed task can also be included. For example, ratings can be provided on a scale of one star to five stars or another rating scale. The service provider can view the rating for a task in order to determine whether or not to improve their service. Customers can also see the ratings of the service providers as submitted by other customers. Financial reporting 440 can also be provided to allow a service provider to view payments made by a customer along with yearly and lifetime revenue totals for a task for a customer. FIG. 5 illustrates a weekly calendar showing tasks to be performed by the service provider during a one week period.

### Variable Scheduling

This technology can use scheduling methods to either increase profitability to a service provider, decrease the cost of the service for a customer, or both simultaneously. By slightly decreasing the frequency of a recurring service (i.e., increasing the time period between performing the recurring service) while continuing to charge the customer the same amount or a slightly increased amount, the service provider's profit may increase and/or the customers total cost may decrease. If the cost of the service is increased, the cost increase may be increased to a level that is not as great as the pro-rata reduction in the frequency for performing the service. This can provide value to both the service provider and the customer. More specifically, the savings that result from the adjustment can be passed along to the service provider, the customer or split between the two. Such scheduling adjustments can be performed using the scheduling module 150 (FIG. 1)

For example, a lawn-mowing task may typically be performed every week for $30 each week. Instead of performing the task every week, the frequency of the task is decreased and the service is performed every two weeks instead. Ordinarily the customer would pay $60 for 2 weeks of mowing, but if the customer is instead charged $45 for cutting every 2 weeks, then the customer has saved 25%. In this instance, the service provider has made an additional $15 (assuming that the service provide takes the same amount of time to mow the lawn), which amounts to a 50% increase over what he would have made. Although the actual increase may be slightly less as it may take slightly more time to mow the longer grass, however, if the mowing time is not more than 50% more than the original task the service provider has the opportunity to still earn more money because the service provider can now perform more tasks. In the instance where there are many customers, then this adjustment can amount to a significant raise for the service provider and a simultaneous savings for the customer.

In the example above, the service provider can still only perform the same number of tasks per week (or maybe slightly fewer tasks but not fewer than would be the pro-rated change in number of tasks), but because the service provider is now charging a little more money for each task performed ($45 versus $30) the service provider can make more per time period for the tasks collectively. Thus, the customer saves money and the service provider makes more money. This same system can work for any task where the frequency is decreased and the price is increased a fraction of the pro-rated amount that the price might otherwise be increased using straight pro-rating and the task itself takes the same amount of time, or if more time, not more than would be the pro-rated amount of time for the increase in the price. This example is also useful because it does not use complex scheduling adaptations, and the customers are assigned to the vendor using methods and systems existing in this technology.

Increasing the frequency of the scheduled service without increasing the total price a pro-rata amount can also provide benefits to both the customer and the service provider. For example, if a house cleaning service was cleaning a customer's house every two weeks, the frequency could be increased to every 10 days. A task going from every 2 weeks to every 10 days, if still priced the same amount per instance, has an increase in frequency on average from 2.17 times per month to 3.04 times per month, an increase of 40.59% and a similar increase in overall cost (if charged the same amount each time work is performed). This is assuming a month has an average of 4.33 weeks per month and 364.2425 days/year. If the difference in the overall cost to the customer for increasing the frequency is split between the customer and the service provider, then individual task cost can decrease for the customer. For instance, increasing the overall cost by 20.285% to the customer, allows the individual instance cost to decrease by 14.43% each time the task is performed. The splitting of the increased value still means that the contractor is making an additional 20.285% overall, the customer is spending less per task but more overall while ending up with a better service. This splitting of the value may also be justified because the house would get less dirty between cleanings and the service provider will have more work to do.

Advanced scheduling can be used to allow for non-standard or non-periodic recurring frequencies and yet still allow for blackout periods. Weekends, holidays, night shifts, day shifts, and other varying schedules may use blackout periods for a service provider where no service will be provided by the service provider during that blackout period. The blackout periods may be entered by a service provider through the blackout scheduling module 160 and stored by the blackout scheduling module 160 in the data store 128. If a decreased or increased frequency task appointment occasionally falls on a blacked out period, the task appointment can be automatically moved to a non-blacked out period according to a method that keeps schedules balanced across the service provider's calendar. This method may assign weightings using a calendar weightings module 162 (FIG. 1) to each of the periods to which the service can be assigned either before and/or after the blackout period. This allows the services being moved to another day to be assigned using the weightings to distribute the services more evenly though the service provider's schedule.

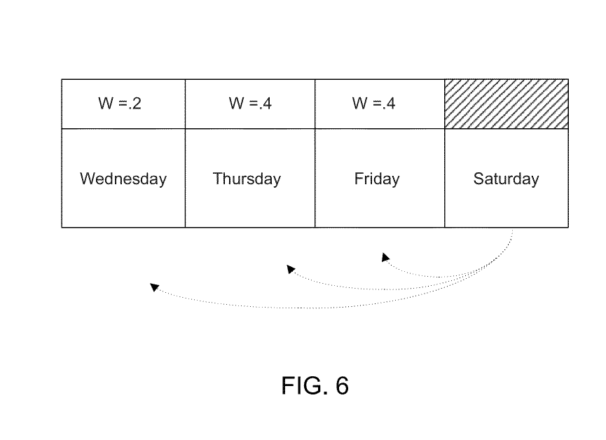

For example, a customer may like to have their lawn mowed every 9 days but the service provider mowing their lawn wants to blackout the service provider's availability on Saturdays and Sundays. Then the lawn is mowed every 9 days, except when the lawn mowing happens to fall on a Saturday, in which case the lawing mowing is moved to Friday 40% of the time, Thursday 40% of the time and Wednesday 20% of the time. FIG. 6 illustrates an example of a calendar with weightings (W) associated with each day except the blackout day(s). While 3 days are shown as possibilities for distributing the task from the blackout day, any combination of days before or after can be used for re-assigning the task. For example, the weightings may be spread over 2 to 14 days or more and the re-assignment days may fall before or after the blackout days or both. Weightings can also be assigned to periods as opposed to assigning weightings to an entire day. For example, a weighting can be assigned to a 12 hour period, a 4 hour period or another rescheduling period. The length of a black out period or a rescheduling period depends on what is setup by the service contractors.

When the recurring event resumes (i.e., the regularly scheduled day is available again) the scheduling method may still begin the scheduling counts from the Saturday the lawn mowing was originally supposed to have landed on and the scheduling may not be calculated from the day to which the lawn mowing was temporarily moved. For example, if the law mowing happens to fall on a Sunday, then the lawn mowing can be moved to Monday 40% of the time, Tuesday 40% of the time and Wednesday 20% of the time. In this example, because the event falling on a blacked out period may be moved to Wednesday in case Monday and Tuesday's schedules are full, the total weighting of service appointments on the days remains approximately equal and on average the service provider's schedule doesn't get unbalanced.

The alternative period scheduling around blackout periods may apply for any combination of blackout periods, available periods, fractional days, hourly periods, minute periods, and any scheduling frequency for tasks. Accordingly, the weightings assigned to periods may vary and the scheduling method can be preemptive to make certain that customer assignments for a service provider do not get overloaded on one day more than other days. The weightings may be set patterns or weighting templates applied for various frequently occurring blackout arrangements or the weightings may be varied dynamically. There may generally be an effective scheduling method or solution for every combination of task frequency, blackout days, and available days (e.g., like the 9 day frequency/2 blackout days example). The technology may also be configured using feedback data to reflect actual scheduling data and the weighting of “a given task being moved to a given period with a certain frequency” to ultimately reflect the scheduling realities encountered over time. With a large enough data history, the data-driven scheduling can be used to dynamically set the weightings or percentages assigned to each day. For example, machine learning methods can be used to improve the scheduling methods used.

The weightings can also be dynamically influenced using many other variables that may be known or collected by the technology. Examples of factors that may affect scheduling or rescheduling around blackout periods may include factors, such as: geographical clustering of tasks, fuel savings, travel times, proximity to the service provider's home base, proximity to the service provider's previous task, proximity to the service provider's next task, load leveling, task duration (i.e., can the task fit in the schedule, with longer tasks being more difficult to schedule), use of genetic algorithms, and other task related factors. These described factors may be used to increase or decrease the value of a weighting for a specific time period in order to accommodate such scheduling dynamics.

A customer's scheduling desires may also be taken into account when scheduling around a blackout period and/or when creating weightings for scheduling around a blackout period. In one configuration, the customer may be asked to provide a preferred time and date for performance of a task due to the existence of the blackout period. For example, the customer may be prompted with the blackout dates and suggested rescheduling dates and times. In response to the prompt, the customer may select a suggested date and time or provide a counter-proposal that is preferable to the customer. Alternatively, a customer interface for initially purchasing a task may be structured to not allow the customer to select a date and time within a pre-existing blackout period for a service provider. This scenario is most likely to apply when the blackout period is known prior to the customer's order with a specific service provider for a task. In another configuration, an original task purchase request by the customer may be used as a basis for forming the weightings applied to the dates and times used to reschedule the task around the blackout period.

The computation of the weightings may also take into account a variety of situations where there are many contractors and many customers that are being scheduled. Similarly, the weightings can be applied where scheduling is being performed for many customers of a single contractor or many contractors are being scheduled for one larger customer.

The technology can be substantially more robust as greater amounts of actual data are incorporated into a scheduler. More specifically, the scheduler can incorporate a feedback loop whereby actual data is used to work out an effective scheduling arrangement in a given geographical area for a given task and to reflect the specific time of year. For example, some scheduling times may have different biases than others (e.g., April scheduling could be different than August in the Boston area, but not in California).

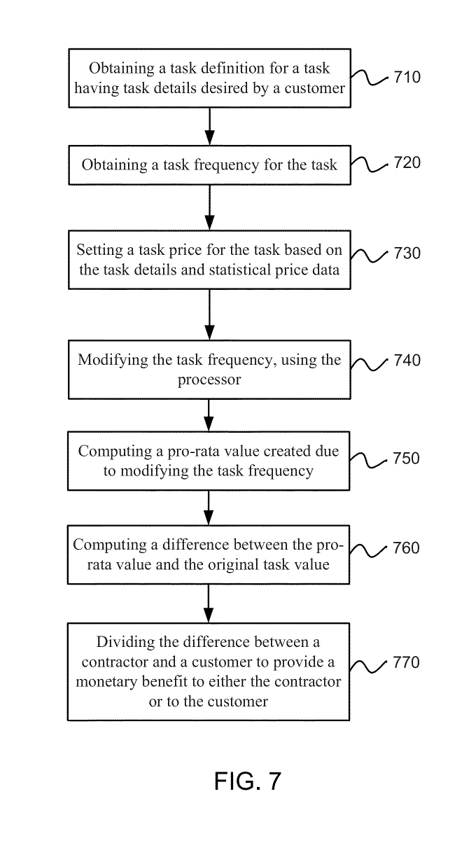

FIG. 7 illustrates a method for modifying a task frequency. The method can include the operation of obtaining a task definition for a task having task details desired by a customer, as in block 710. The task definition can include details that will be performed for the task. For example, a task definition for pool cleaning may include skimming the pool with a net, applying pool chemicals, and backwashing the filter. The task frequency for the task may also be obtained, as in block 720. The task frequency may be how often the task is performed for the customers. Task frequency may be multiple times per day, every day, once a week, every month, quarterly, and so forth.

A task price can be set for the task based on the task details and statistical price data, as in block 730. This task price may be a base task price for performing the task at an expected frequency. For example, an expected frequency for lawn mowing may be 7-9 days. The task price may also be set at a different amount based on a scheduled frequency (e.g., the task is performed once per month as opposed to the expected weekly service).

The task frequency can be modified, as in block 740. This may mean the task frequency is increased or decreased. When the task frequency is decreased the customer may be charged an increased task price. For instance, the task frequency may be decreased while increasing the task price by an amount that is less than a pro-rata decrease in the task frequency. Conversely, the task frequency can be increased while decreasing the task price and charging the customer a decreased task price that is less than a pro-rata increase in task frequency. In the example where the task frequency is decreased while increasing the task price, a resulting monetary benefit may be shared between the service provider and the customer. In the example where the task frequency is increased while decreasing the task price, the contractor receives an overall monetary benefit and the customer may receive a more frequent service and the benefit of a per-task decrease in price (albeit an overall increase in price).

A pro-rata value identified due to modifying the task frequency can be computed using the system, as in block 750. The pro-rata value can be defined as the increase in value that a customer would otherwise pay for the increased or decreased service in ratio to the original task price. In addition, a difference between the pro-rata value and the original task value can be computed as in block 760. The computed difference can be divided between a service provider and a customer to provide a benefit to either the service provider or to the customer or both, as in block 770. This benefit can be a monetary benefit provided to both the service provider and the customer or another value benefit. Alternatively, the benefit can be a task frequency benefit to the customer where a task is performed more frequently than that task would otherwise be performed for an overall increase in price that is less than the ostensibly pro-rated increase, and a discount on a per task basis.

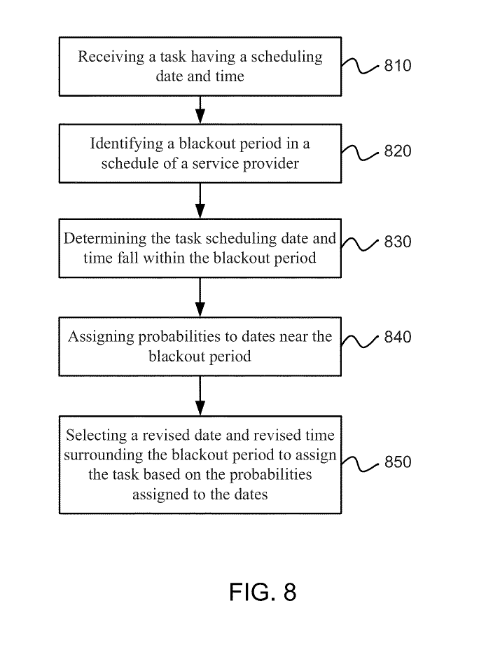

FIG. 8 illustrates a method for scheduling tasks in response to blackout periods. The method can include receiving a task having a scheduling date and time, as in block 810. This task can be identified as having a desired scheduling period that has not been scheduled yet based on a repeating appointment. A further operation can be identifying a blackout period in a schedule of a service provider, as in block 820. This blackout period can be a weekend, a holiday, or another time period the service provider has designated that the service provider is not available to provide services. The unavailable time may be a regularly scheduled unavailable time or the unavailable time may be an unexpected change in the service provider's schedule. In other example, tasks for which this re-scheduling is useful can include tasks where the scheduling date and time for the task are a recurring scheduled date and time.

The task scheduling date and time can be determined as falling within the blackout period, as in block 830. In other words, the task is desired to be rescheduled to another time period or time slot that the service provider has available. Since any other appointments or recurring tasks the service provider has which fall on that blackout period will also need to be re-scheduled, the task from a blackout period or a series of blackout periods are desired to be distributed over a number of work periods for the service contractor. Weightings can be assigned to periods outside the blackout period, as in block 840. For example, if the blackout period is a single day holiday in the middle of a week, then weightings can be assigned to an available period before and the available period after. For example, a 0.4 weighting can be assigned to the period before and a 0.6 weighting can be assigned to the period after, and then the assignment where the re-assigned task is placed on one of the period is performed randomly using the weighting.

A revised date and revised time outside the blackout period can be selected to assign the task based on the weightings assigned to the periods, as in block 850. For example, a random number can be generated to see which period to assign a task that is being moved based on the weightings assigned to the periods. In this sense, a revised date and revised time can be selected using random selection. What may be expected in this case is a distribution of the tasks that is shaped by the weightings assigned to the periods. Assigning a task from a blackout day to another work day using weightings can help to keep the service provider's schedule balanced over the periods to which the tasks are shifted.

Such weightings might also vary a weighting to take into account scheduling convenience based on other proximate tasks. For example, if scheduling a task on Wednesday may cause an increase in the service provider's overall driving time by 60 minutes, but scheduling the task on Tuesdays will only increase the service providers overall driving time by 30 minutes, then the Tuesday reschedule can be weighted by a factor of 2 to indicate Tuesday is probabilistically favored, in this case, by twice as much as Wednesday.

In an example configuration, greater weighting values can be applied to periods adjacent to the blackout period as compared to weighting values for periods farther away from the blackout period. This means that re-assigned tasks are more likely to fall closer to the blackout periods and the re-assigned tasks are less likely to be moved to periods farther away from the blackout period. This is helpful with tasks that need to be serviced as closely to the originally scheduled period as possible. Examples of such time sensitive tasks may include tasks such as lawn mowing, cleaning, air conditioning repair, and other relatively time sensitive tasks.

Feedback from service providers or customers regarding schedule balancing can be received to determine whether the weightings assigned to the days or the period distribution for re-scheduling are useful. In response to the feedback, the weightings assigned to the periods, the period organization, and the number of days used for distribution can be revised to provide a shaping of the re-assigned task in a way that fits customer's desires. In addition, statistical scheduling feedback can be used to revise the weightings assigned to the periods to shift tasks to days that have statistically lighter task loads or to shift task to periods that consumers are more likely to statistically desire.

In another example, the described shifting of a task from a blackout period can be used to shift a recurring task from a first service team to a second service team temporarily. In the case where the blackout period has been positively identified as a vacation period, then the task may be shifted to a second service team who will cover the tasks on a one time basis while the first service team is on vacation. Where the first service team has a significant number of tasks that need to be shifted, assigning the weightings to multiple periods for the second service team will aid in distributing the vacation workload from the first service team to the second service team with a reduced chance of overloading the second service team who is covering for the vacation. In a further example, the first and second service team may service teams which belong to a single owner. Alternatively, each service team may be an independent service provider.

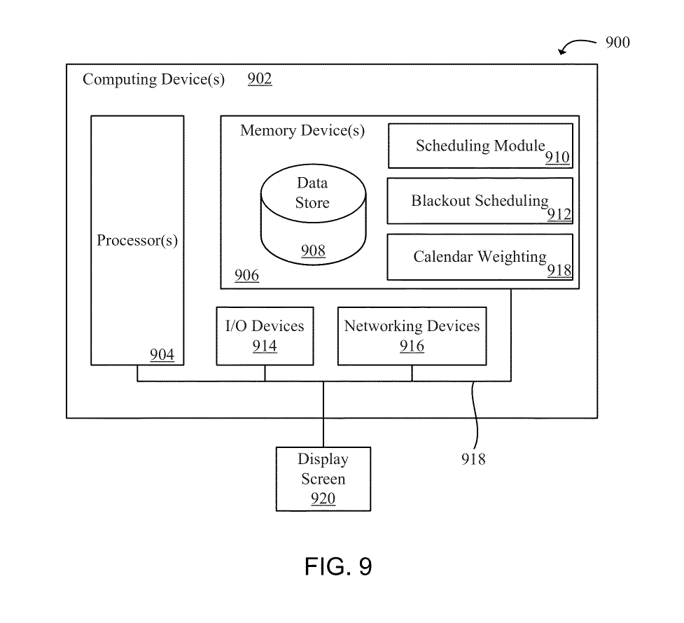

FIG. 9 is block diagram 900 illustrating an example of a computing device 902 that may be used for discovering content. In particular, the computing device 902 is illustrates a high level example of a device on which modules of the disclosed technology may be executed. The computing device 902 may include one or more processors 904 that are in communication with memory devices 906. The computing device 902 may include a local communication interface 918 for the components in the computing device. For example, the local communication interface may be a local data bus and/or any related address or control busses as may be desired.

The memory device 906 may contain modules that are executable by the processor(s) 904 and data for the modules. Located in the memory device 906 are modules executable by the processor. For example, a scheduling module 910, a blackout scheduling module 912, a calendar weighting module 918 and other modules may be located in the memory device 906. The modules may execute the functions described earlier. A data store 908 may also be located in the memory device 906 for storing data related to the modules and other applications along with an operating system that is executable by the processor(s) 904.

Other applications may also be stored in the memory device 906 and may be executable by the processor(s) 904. Components or modules discussed in this description that may be implemented in the form of software using high programming level languages that are compiled, interpreted or executed using a hybrid of the methods.

The computing device may also have access to I/O (input/output) devices 914 that are usable by the computing devices. An example of an I/O device is a display screen 920 that is available to display output from the computing devices. Other known I/O devices may be used with the computing device as desired. Networking devices 916 and similar communication devices may be included in the computing device. The networking devices 916 may be wired or wireless networking devices that connect to the internet, a LAN, WAN, or other computing network.

The components or modules that are shown as being stored in the memory device 906 may be executed by the processor(s) 904. The term “executable” may mean a program file that is in a form that may be executed by a processor 904. For example, a program in a higher level language may be compiled into machine code in a format that may be loaded into a random access portion of the memory device 906 and executed by the processor 904, or source code may be loaded by another executable program and interpreted to generate instructions in a random access portion of the memory to be executed by a processor. The executable program may be stored in any portion or component of the memory device 906. For example, the memory device 906 may be random access memory (RAM), read only memory (ROM), flash memory, a solid state drive, memory card, a hard drive, optical disk, floppy disk, magnetic tape, or any other memory components.

The processor 904 may represent multiple processors and the memory 906 may represent multiple memory units that operate in parallel to the processing circuits. This may provide parallel processing channels for the processes and data in the system. The local interface 918 may be used as a network to facilitate communication between any of the multiple processors and multiple memories. The local interface 918 may use additional systems designed for coordinating communication such as load balancing, bulk data transfer and similar systems.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for modifying a task frequency, comprising:
obtaining a task definition for a task having task details desired by a customer;
obtaining a task frequency for the task;
setting a task price for the task based on the task details, task frequency and statistical price data, using a processor;
modifying the task frequency, using the processor;
computing a pro-rata value created due to modifying the task frequency using the processor;
computing a difference between the pro-rata value and the task price using the processor; and
dividing the difference between a service provider and a customer to provide a monetary benefit to either the service provider or to the customer using the processor.

2. The method as in claim 1, further comprising providing a monetary benefit to both the service provider and the customer.

3. The method as in claim 1, further comprising providing a task frequency benefit to the customer.

4. The method as in claim 1, wherein modifying the task frequency further comprises decreasing the task frequency while charging the customer an increased task price.

5. The method as in claim 1, wherein modifying the task frequency further comprises decreasing the task frequency while increasing the task price by an amount that is less than a pro-rata value increase in the task price associated with a decrease in the task frequency.

6. The method as in claim 1, wherein modifying the task frequency further comprises increasing the task frequency while decreasing the task price and charging the customer the decreased task price that is less than a pro-rata value decrease in the task price associated with an increase in the task frequency.

7. The method as in claim 1, wherein modifying the task frequency further comprises increasing the task frequency while decreasing the task price and providing a monetary benefit to the service provider and providing a per-task monetary benefit and a frequency benefit to the customer.

8. A method for scheduling tasks in response to blackout periods, comprising:
receiving a task having a scheduled date and time;
identifying a blackout period in a schedule of a service provider;
determining that the task date and time fall within the blackout period using a processor;
assigning weightings to a time period outside the blackout period using the processor;
selecting a revised time period outside the blackout period to assign the task, using the processor, based on the weightings assigned to the time period.

9. The method as in claim 8, further comprising applying greater weighting values to time periods adjacent to the blackout period as compared to weighting values for time periods temporally farther from the blackout period.

10. The method as in claim 8, wherein the scheduling date and time for the task are a recurring scheduled date and time.

11. The method as in claim 8, wherein the revised date and revised time are selected using random selection.

12. The method as in claim 8, further comprising revising the weightings assigned to the time periods based on feedback from service providers regarding schedule balancing.

13. The method as in claim 8, further comprising revising the weightings assigned to the time periods based on statistical scheduling feedback.

14. The method as in claim 8, further comprising assigning weightings to time periods near to the blackout period.

15. The method as in claim 8, further comprising selecting a revised time period for rescheduling the task using a second service team.

16. The method as in claim 15, further comprising rescheduling tasks for the service provider while the service provider is on vacation.

17. The method as in claim 8, wherein assigning weightings to a time period outside the blackout period further comprises adjusting weightings for a time period outside the blackout period based on a customer preferred date and time outside the blackout period.

18. The method as in claim 17, wherein the customer preferred date is specified at task purchase time.

19. A system for task scheduling adjustments for a blackout period, comprising:
a task definition module to obtain a task definition having task details for a task to be performed for a customer;
a fixed price module to set a task price for the task based on the task details and statistical price data;
a calendar weighting module to assign weightings to a period outside the blackout period using a processor; and
a blackout scheduling module to select a revised date and revised time outside the blackout period to assign the task, using the processor, based on the weightings assigned to the time periods.

20. A system as in claim 19, wherein the time period includes a plurality of time periods with weightings outside the blackout period.

21. A system as in claim 19, further comprising generating a random number to use with the weightings in selecting a time period to re-schedule a task outside a blackout period.

22. A system as in claim 19, further comprising selecting a revised time period for rescheduling the task using the calendar of a second service team of a same service provider's.

23. A method for modifying a task frequency, comprising:
setting a task price for a task based on task details and statistical price data, using a processor;
modifying the task frequency of the task, using the processor;
computing a pro-rata value created due to modifying the task frequency using the processor; and
dividing the pro-rata value between a service provider and a customer to provide a value benefit to either the service provider or to the customer using the processor.
